(19) United States
(12) Patent Application Publication
(10) Pub. No.: US 2003/0202003 A1
(43) Pub. Date: Oct. 30, 2003

(54) Method and apparatus for enhanced user interface display systems

(76) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/131,995

(22) Filed: Apr. 25, 2002

(51) Int. Cl. G09G 5/00

(52) U.S. Cl. 345/710; 345/728

(57) ABSTRACT

A system and method is disclosed related to a display device including a rotating mechanism that allows the display device to automatically turn around on one of its axis's so that a user can face either the display's viewing area or the back of the display device. When the display device is not active or off, the back of the display device is presented to the user. In this mode, the screen of the display device can be protected and concealed. When the display device is activated through a variety of means, the display device rotates 180 degrees as information begins to appear on the screen of the display device.

### FIELD OF THE INVENTION

The present invention relates to display systems, more particularly, the invention relates to a method and system for automatically rotating displays to enhance the user interface.

### BACKGROUND OF THE INVENTION

When considering human-machine interface design, human factors should be considered to improve the user interface. Human factors is a body of knowledge about human limitations, human abilities, and other human characteristics that are relevant to design. Human factors engineering is the application of human factors information to the design of machines, systems and environments for safe and effective human use. In this regard, Human-Computer Interaction (HCI) is concerned with the design, evaluation and implementation of interactive computing systems for human use, and the major phenomena surrounding them. Human factors aids display efficiency in several ways and should be considered in design because:

(1) human factors acts as a bridging function between the display system and the operator;

(2) modern display systems are approaching minimum design limits on ratio of cost to performance;

(3) better performance can generally be achieved only through more effective human-device integration;

(4) intelligent design is often suppressed in following fashionable trends;

(5) human factors design generally cannot be an add-on after the design process; and

(6) late decisions in the development life cycle cost is expensive to change.

In related applications of human-machine interfaces, conventional displays used for marketing purposes may contain, for example, advertising materials, working models, or a product image or video playing or arranged in an attractive manner on the display. Such displays are typically in a fixed location or position, which limit the viewing angle. In addition, the static environment of the display lacks realism.

Conventional rotatable platform display units for retail display purposes in stores are also known. Typical rotatable platform display units employ a driven table, which is geared to a motor. However, such rotatable platform display units merely rotate in a circular manner to display a product mounted on the platform.

In human-machine interface design, associating an action with an everyday activity familiar to the user is very important for creating user-friendly systems. For example, in anthropomorphic robotic applications, an appropriate environment can help enhance the realism and the user experience. This is beneficial because such anthropomorphic systems may be used for marketing, advertising and information dissemination.

Accordingly, there is a need for improved display systems that incorporate human factors designs for improved realism and user experience.

### SUMMARY OF THE INVENTION

Various aspects and embodiments of the invention are directed to an information system including a display device and a rotating mechanism that allows the display device to automatically turn around on one of its axis's so that a user can face either the display's viewing area or the back of the display device. When the information system is not active or off, the back of the display device is presented to the user. In this mode, the screen of the display device can be protected and concealed. When the display device is activated through a variety of means, the display device rotates 180 degrees as information begins to appear on the screen of the display device. This is in analogy to a waking up action or to a person who has his back turned to someone and then turns to face the accosting person to begin a conversation. When the display device is inactivated or switched off, it returns to its original position by turning 180 degrees.

In other embodiments, the back surface of the display device can be used to display advertisements, logos, trademarks, product data or other such information. The waking up action may be combined with a corresponding sound (e.g., a product jingle) enhancing the wake up effect further. The whole sequence may also be used to create a strong branding effect around the display device.

In yet other embodiments, the rotation of the display device's viewing areas may be virtually performed via software.

One embodiment of the present invention is directed to a system including a display having a front, information-viewing area and a back area. The system also includes a rotating mechanism that is capable of rotating the display to present the front information viewing area or the back area. The system further includes a sensor for triggering the system to automatically enter a first mode or a second mode. In the first mode the back area is presented to a user of the system and in the second mode the front information viewing area is presented to the user.

Another embodiment of the present invention is directed to a method for presenting information to a viewer using a display system including a display and a rotating mechanism. The method includes the steps of presenting a back of the display when the display system is in a sleep mode and detecting an activation of the display system, which indicates that the display system should enter an information presentation mode. The display is then rotated from the back to a front information viewing area of the display and information is presented to the viewer.

Yet another embodiment of the present invention is directed to an information system including a display, a sensor for detecting whether the display should be in a sleep mode or a non-sleep mode, and means for automatically simulating rotation of a viewing area of the display means to allow the display system to switch from the sleep mode to the non-sleep mode in accordance with a signal from the sensor means. In the non-sleep mode, the information system is in a normal operation mode.

Still further features and aspects of the present invention and various advantages thereof will be more apparent from the accompanying drawings and the following detailed description of the preferred embodiments.

### BRIEF DESCRIPTION OF THE DRAWINGS

FIG. 1 shows a conceptual diagram of a system in which a preferred embodiment of the present invention can be implemented.

FIG. 2 shows an LCD display in accordance with one embodiment of the present invention.

FIG. 3 shows an LCD display in accordance with another embodiment of the present invention.

FIG. 4 is a flowchart showing a human-machine interface method in accordance with a preferred embodiment of the invention.

### DETAILED DESCRIPTION OF THE INVENTION

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for purposes of simplicity and clarity, detailed descriptions of well-known devices, circuits, and methods are omitted so as not to obscure the description of the present invention with unnecessary detail.

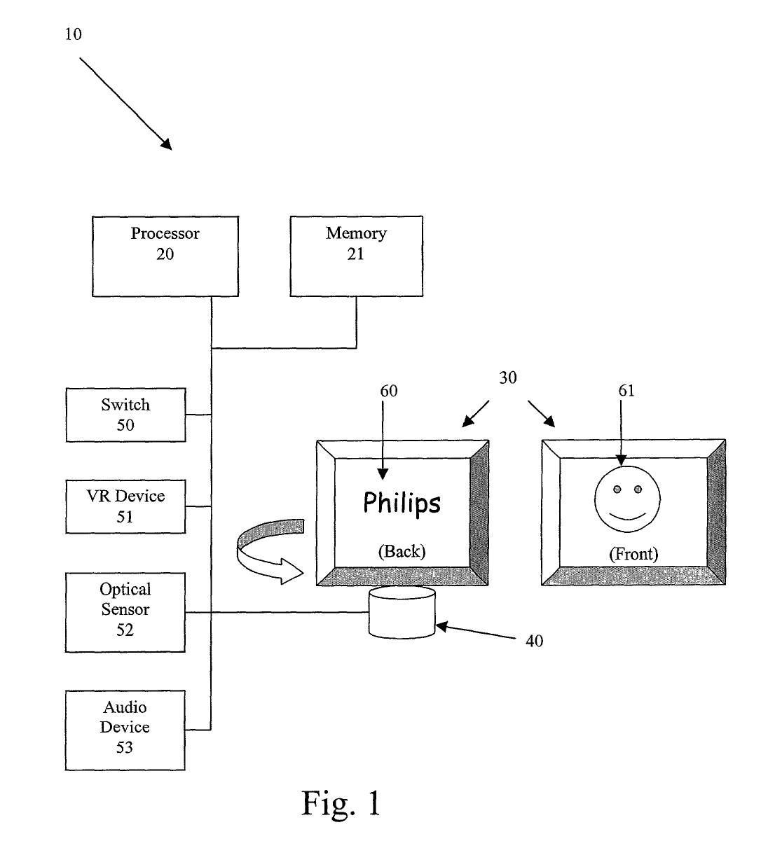

FIG. 1 shows a conceptual diagram describing exemplary physical structures in which the some embodiments of the invention can be implemented. This illustration describes the realization of a system and method using elements contained in a personal computer. The system and method can be implemented by a variety of means in both hardware and software, and by a wide variety of controllers and processors. For example, it is noted that a laptop or palmtop computer, a personal digital assistant (PDA), a telephone with a display, television, an information kiosk or any other type of similar display device may also be used.

The display system 10 shown in FIG. 1 includes a processor 20 and a memory 21. The processor 20 may represent, e.g., a microprocessor, a central processing unit, a computer, a circuit card, an application-specific integrated circuit (ASICs). The memory 21 may represent, e.g., disk-based optical or magnetic storage units, electronic memories, as well as portions or combinations of these and other memory devices.

Various functional operations associated with the display system 10 may be implemented in whole or in part in one or more software programs stored in the memory 21 and executed by the processor 20. It is also noted that various elements shown in FIG. 1 may be combined or integrated.

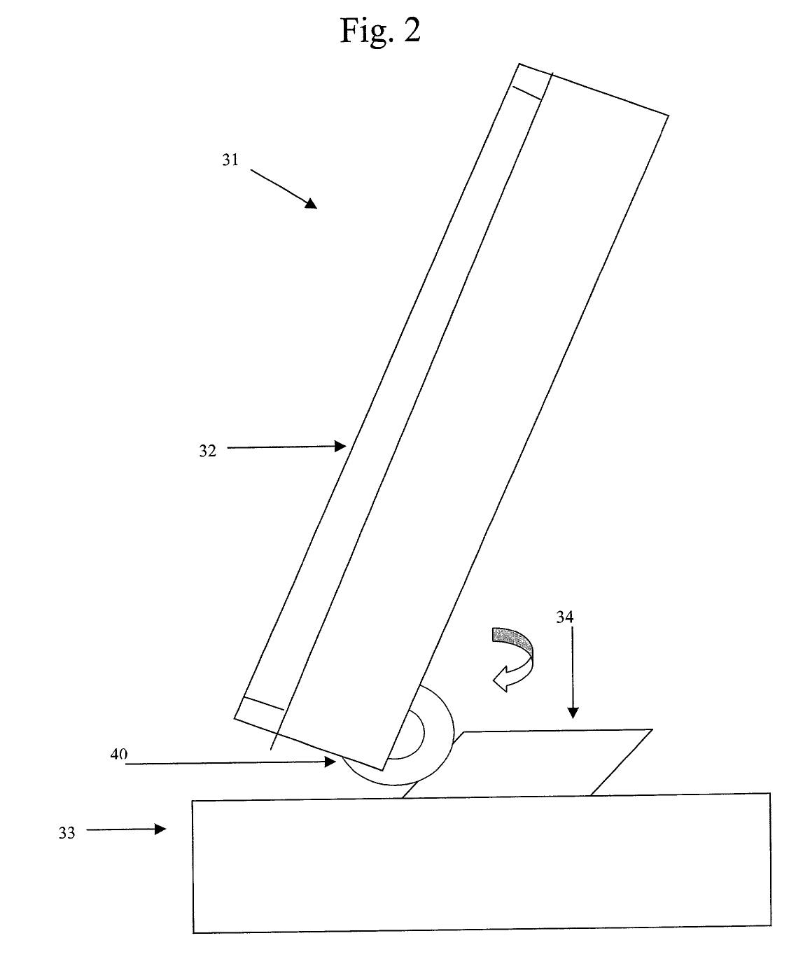

The display system 10 includes a display device 30 such as a CRT, plasma display, projection display or LCD. Preferably, the display device 30 is an LCD monitor 31. As shown in FIG. 2, the LCD monitor 31 may be constructed using: a LCD display unit 32, a stand unit 33, and a stand-display interface 34. The LCD display unit 32 front and rear housings are assembled into a single housing containing both a LCD and a PCB (Printed Circuit Board). The stand unit supports the display unit on a support surface and includes a plurality of connectors for power and signal cables.

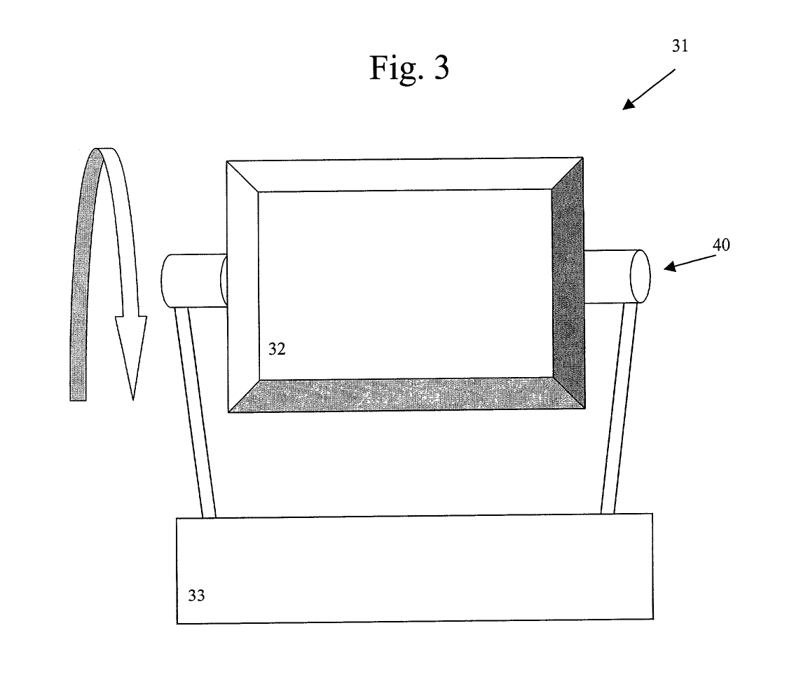

The display device 30 is rotatably mounted on a support so that the display device 30 can turn around on one or more of its axis's. FIG. 3 shows another embodiment in which the display device 30 rotates on a different axis as compared to FIG. 2. The support may be integral with the display device 20 or a separate platform on which the display device 30 is placed. A rotating mechanism 40 is used to rotate the display device 30. The display device 30 may be adapted to be rotated at predetermined speeds, such as, for example, 5-30 rpm.

The rotating mechanism 40 may comprise a motor such as a servomotor to rotate the display device to predetermined positions. A servomotor is a motor in a servomechanism that supplements a primary control by correcting position or motion. A servomechanism is a device for automatically correcting the performance of a mechanism.

In the motion control industry today many different types of motors are used to provide servomotor control in machine designs. Servo control may be performed using a digital signal processor (DSP) and a motor driver using a PWM Sine wave vector output. A software algorithm may be used as a servo control loop. In such algorithms, position information is used to perform closed loop control of the rotor's position by detecting and correcting for the error in position versus a defined target position.

A multi-axis servomotor chipset, with electronic gearing capability may also be used. Such chipsets are capable of controlling up to four DC motors simultaneously. A predefined gear ratio can range from 1 to 16,384 in negative and positive directions, with a resolution of 32 bits. This also allows for the gear ratio quickly to be adaptively changed.

The rotating mechanism 40 is adapted to be powered by a storage battery or driven directly from a 115 VAC outside power supply. The electrical system may be set up so that the battery or batteries continuously charge while the system is operating directly from an AC power supply. The battery may be charged from an AC powered charger for charging the storage battery directly from an AC power supply.

It will be appreciated that the amplitude of the torque exerted upon rotating mechanism 40 may be selected to match the particular load provided by display device 30.

The rotation mechanism 40 produced in accordance with the invention should desirably have different torque amplitudes depending upon the anticipated final use. Higher torque is necessary for use with displays expected to be heavy, or to extend large distances from the axis of rotation, or to otherwise have high moments of inertia.

The rotation mechanism 40 may be also comprise software that simulates rotation of the display device 30 viewing area. This gives the appearance of the viewing area flipping over or rotating when the display system 10 (e.g., a PDA) is activated.

The display system also includes an activation mechanism. For example, as shown in FIG. 1, the activation mechanism may include a switch 50, a voice recognition device 51, and an optical sensor 52. Using the switch 50, a user may simply turn on (i.e., wake up) the display system 10. Alternatively, the voice recognition device 51 may activate/deactivate the display system 10 in response to a voice command (e.g., wake up or sleep) from the user. The display system 10 may also automatically wake up when the optical sensor 52 senses that the user is near the display system 10.

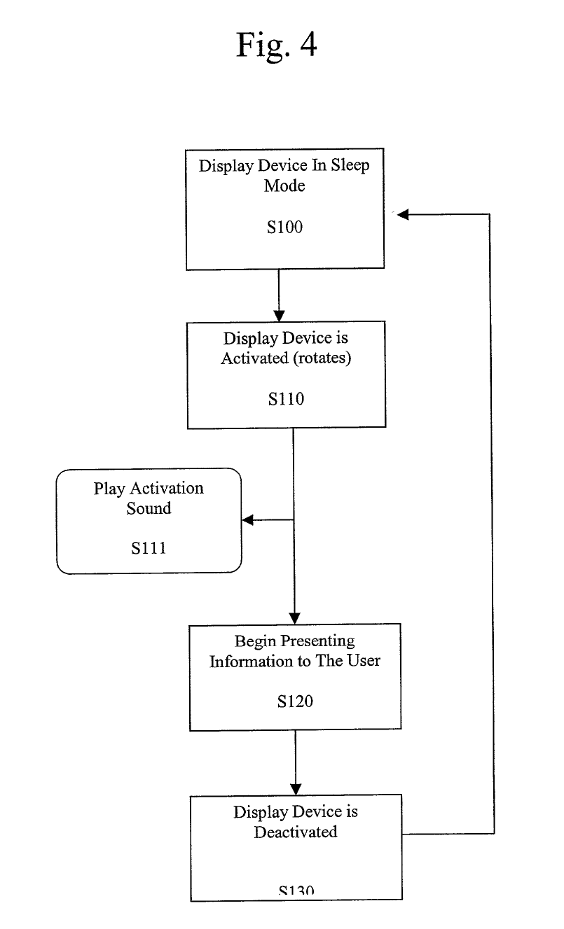

FIG. 4 is a flowchart showing a human-machine interface method in accordance with a preferred embodiment of the invention. In step S100, the display device is in the inactive or sleep mode. As discussed above the back or rear of the display device is presented. As shown in FIG. 1, the back of the display device may have a logo, trademark 60, or other advertisement. In this mode, the screen of the display device can be protected and concealed.

When the display device is activated (Step S110), the display automatically rotates so that the front of the display is presented to the user. The display device is activated through a variety of means as discussed above. The display will typically rotate 180 degrees as information begins to appear on the screen (S120) of the display device. It is noted that other degrees of rotation may also be used, e.g., 90 or 270 degrees, as long as the front of the display device is ultimately presented to the user.

The activation is in analogy to a waking up action or to a person who has his back turned to someone and then turns to face the accosting person to begin a conversation. In this regard, as shown in FIG. 1, a talking head 61 may be display to the user.

The waking up action may be combined with a corresponding sound, S111, (e.g., a product jingle) via an audio device 53 shown in FIG. 1. This even further enhances the wake up effect. The whole sequence may also be used to create a strong branding effect around the display device.

When the display is inactivated or switched off (S130), the display returns to its original position (i.e., the back is presented to the user) by turning 180 degrees. It is noted that the inactivation may take place in a variety of ways, e.g., the user may walk away from the display device 10 or stop interacting with the display device for a predetermined length of time.

In an alternative embodiment, a simulated rotation of the display device's viewing area may be virtually performed via software. In this regard, a program may be stored in the memory 21 that performs the simulated rotation. This embodiment allows for the teachings of the invention to be extended to devices such as PDA's, laptop computers and cell phones with a display.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. A system comprising:
a display having a front, information-viewing area and a back area;
a rotating mechanism coupled to the display that is capable of rotating the display to present the front information viewing area or the back area;
a sensor coupled to the display system for triggering the display system to automatically enter a first mode or a second mode,
wherein in the first mode the back area is presented to a user of the display system and in the second mode the front information viewing area is presented to the user.

2. The system of claim 1, wherein the display comprises an LCD, a CRT, a plasma display or a projection display.

3. The system of claim 1, wherein the rotating mechanism comprises a servomotor.

4. The system of claim 1, wherein the sensor comprises an on/off switch.

5. The system of claim 1, wherein the sensor comprises a voice recognition device capable of recognizing voice commands.

6. The system of claim 1, wherein the sensor comprises an optical sensor capable of detecting the presence of the user.

7. The system of claim 1, wherein the back area of the display includes a logo, a trademark, or product information.

8. The system of claim 1, wherein the rotating mechanism rotates the display 180 degrees when the display enters the second mode from the first mode.

9. The system of claim 1, wherein the first mode is a sleep mode and the second mode is an information presentation mode.

10. The system of claim 9, wherein when the information presentation mode is active, a talking head is presented to the user.

11. The system of claim 1, further comprising an audio device capable of producing a sound when the display system switches between the first and second modes.

12. A method for presenting information to a viewer using a display system including a display and a rotating mechanism, the method comprising the steps of:
presenting a back of the display when the display system is in a sleep mode;
detecting an activation of the display system, which indicates that the display system should enter an information presentation mode;
rotating the display from the back to a front information viewing area of the display; and
presenting information to the viewer.

13. The method of claim 12 further comprising the step of providing a sound when the display is rotated to the information presentation mode.

14. The method of claim 12, wherein the detecting step including detecting whether an on/off switch is activated.

15. The method of claim 12, wherein the detecting step includes recognizing a voice command from the viewer.

16. The method of claim 12, wherein the detecting step includes detecting the presence of the viewer using an optical sensor.

17. The method of claim 12, wherein when the back of the display is presented, the back includes a logo, a trademark, or product information.

18. The method of claim 12, wherein the presenting information step includes presenting a talking head to the viewer.

19. An information system comprising:
a display means;
sensor means for detecting whether the display means should be in a sleep mode or a non-sleep mode; and
means for automatically simulating rotation a viewing area of the display means to allow the display system to switch from the sleep mode to the non-sleep mode in accordance with a signal from the sensor means,
wherein in the non-sleep mode the information system is in a normal operation mode.

20. The information system of claim 19, wherein the information system comprises a PDA, telephone, laptop computer or a portable electronic device.
